(19) United States
(12) Patent Application Publication
(10) Pub. No.: US 2015/0085922 A1
(43) Pub. Date: Mar. 26, 2015

(54) APPARATUSES AND METHODS FOR REDUCING RATE AND DISTORTION COSTS DURING ENCODING BY MODULATING A LAGRANGIAN PARAMETER

(71) Applicant: Magnum Semiconductor, Inc., Milpitas, CA (US)

(72) Inventors: Krzysztof Hebel, Kitchener (CA); Eric Pearson, Conestogo (CA)

(73) Assignee: Magnum Semiconductor, Inc., Milpitas, CA (US)

(21) Appl. No.: 14/037,148

(22) Filed: Sep. 25, 2013

(51) Int. Cl. H04N 19/124; H04N 19/176; H04N 19/147

(52) U.S. Cl. CPC H04N 19/0009; H04N 19/00175; H04N 19/00278
USPC 375/240.03

(57) ABSTRACT

Examples of apparatuses and methods for reducing rate and distortion costs during encoding by modulating a Lagrangian parameter are described herein. An example apparatus may include an encoder configured to provide an encoded bitstream based on a video signal. The encoder is configured to determine first rate and distortion values associated with a first quantization strength and a first Lagrangian parameter value for encoding a coding unit of the video signal. The encoder is further configured to select a second quantization strength and a second Lagrangian parameter value for encoding the coding unit that results in second rate and distortion values that are lower than the first rate and distortion values.

### TECHNICAL FIELD

Embodiments described relate to video encoding, and in particular to performing rate-distortion optimization of quantized transform coefficients.

### BACKGROUND

Typically, signals, such as audio or video signals, may be digitally encoded for transmission to a receiving device. Video signals may contain data that is broken up in frames over time. Due to bandwidth requirements, baseband video signals are typically compressed by using video encoders prior to transmission/storage. Video encoders may employ a coding methodology to encode macroblocks within a frame using one or more coding modes. In many video encoding standards, such as MPEG-1, MPEG-2, MPEG-4, H.261, H.262, H.263, H.264, etc., a macroblock denotes a square region of pixels, which is 16×16 in size. Most of the coding processes (e.g. motion compensation, mode decision, quantization decision, etc.) occur at this level. Note that in HEVC, the concept of macroblock is extended to larger block size referred as a coding unit.

Coding methodologies may select a coding mode from one or more coding modes based on a balance of a desired reconstruction quality of the encoded macroblock versus a bandwidth cost to transmit the encoded macroblock, commonly referred to as rate-distortion (RD) optimization. As part of the encoding process, a residual (the difference between the original block of pixels and the corresponding motion-compensated prediction) of the macroblock is transformed into a block of coefficients, and the block of coefficients is quantized. Typically, the quantization strength is selected, and a Lagrangian control parameter is determined based on the selected quantization strength. This may be done based on an empirical relationship between the quantization strength and the Lagrangian parameter. Together, the Lagrangian control parameter and the quantization strength control the quality and bit cost to encode the macroblock. Generally, a higher quality encoding has less distortion and a higher bitrate. The quantization strength is determined based on a quantization parameter (QP). In conventional encoders, the QP may be provided to the encoder or generated by the encoder in an adaptive manner, based on the content being encoded. Conventional encoders use the received or generated QP and Lagrangian control parameter value combination to provide an encoded macroblock having particular distortion and rate values.

### BRIEF DESCRIPTION OF THE DRAWINGS

FIG. 1 is a block diagram of an encoding system with quantization and Lagrangian parameter modulation according to an embodiment of the disclosure;

FIG. 2 is a block diagram of an encoding system with quantization and Lagrangian parameter modulation according to an embodiment of the disclosure;

FIG. 3 is a flow diagram of an embodiment of a method of modulating a quantization and Lagrangian parameter according to an embodiment of the disclosure;

FIG. 4 is a plot of an exemplary rate-distortion curve illustrating the operation of quantization and Lagrangian parameter modulation according to an embodiment of the disclosure;

FIG. 5 is a schematic illustration of a media delivery system according to an embodiment of the disclosure; and

FIG. 6 is a schematic illustration of a video distribution system that may make use of encoders described herein.

### DETAILED DESCRIPTION

Certain details are set forth below to provide a sufficient understanding of embodiments of the disclosure. However, it will be clear to one having skill in the art that embodiments of the disclosure may be practiced without these particular details, or with additional or different details. Moreover, the particular embodiments described herein are provided by way of example and should not be used to limit the scope of the disclosure to these particular embodiments. In some instances, well-known video components, encoder or decoder components, circuits, control signals, timing protocols, and software operations have not been shown in detail in order to avoid unnecessarily obscuring the disclosure.

Embodiments described herein may be used with a variety of different coding units. Some examples are provided herein with regard to using macroblocks as the coding unit; however other coding units may additionally or instead be used in other examples.

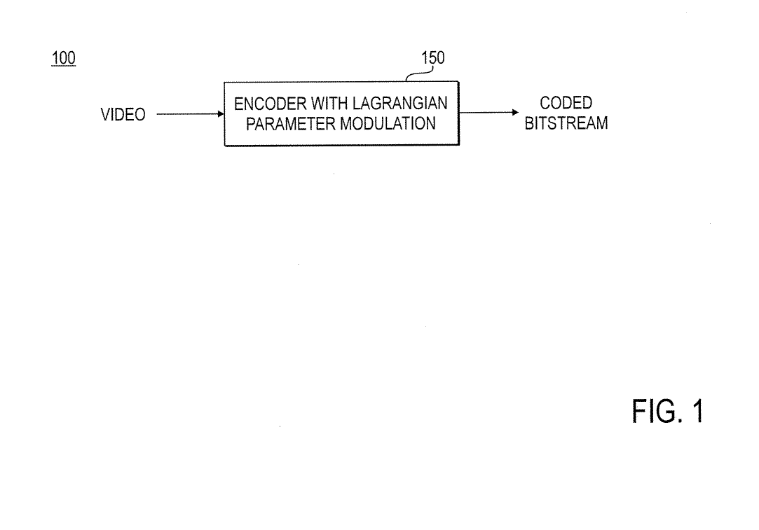

FIG. 1 is a block diagram of an encoding system 100 according to an embodiment of the disclosure. The encoding system 100, which may be implemented in hardware, software, firmware, or combinations thereof, may include an encoder with Lagrangian parameter modulation 150 that may include control logic, logic gates, processors, memory, and/or any combination or sub-combination of the same, and may be configured to encode and/or compress a video signal to produce a coded bit-stream signal using one or more encoding techniques, examples of which are described herein. The encoder 150 may determine whether a different combination of quantization strength and a Lagrangian parameter lambda (2) value provides an encoded macroblock having lower distortion (e.g., better quality) and a lower rate (e.g., lower bit cost) as compared with an initial quantization strength and lambda value derived from the initial quantization strength (e.g., an initial lambda value).

The encoder 150 may be implemented in any of a variety of devices employing video encoding, including, but not limited to, televisions, broadcast systems, mobile devices, and both laptop and desktop computers. In at least one embodiment, the encoder 150 may include an entropy encoder, such as a variable-length coding encoder (e.g., Huffman encoder, context-adaptive variable length coding (CAVLC) encoder, or context-adaptive binary arithmetic coding (CABAC) encoder), and/or may be configured to encode data in coding units, for instance, at a macroblock level. Each coding unit (e.g. macroblock) may be encoded in intra-coded mode, inter-coded mode, bidirectionally, or in any combination or subcombination of the same.

As an example, the encoder 150 may receive and encode a video signal that, in one embodiment, may include video data (e.g., frames). The video signal may be encoded in accordance with one or more encoding standards, such as MPEG-2, MPEG-4, H.263, H.264, and/or HEVC, to provide the encoded bitstream. The encoded bitstream may be provided to a data bus and/or to a device, such as a decoder or transcoder (not shown). A video signal may be encoded by the encoder 150 based on a quantization strength and a lambda value. The quantization strength may be based on a quantization parameter (QP). The encoder 150 may select a combination of the QP value and the lambda value based on a desired rate-distortion (RD) cost of encoding a macroblock. The encoder 150 may determine several rate and distortion points using different QP and lambda value combinations to determine respective RD costs of encoding the macroblock. The encoder 150 may select QP and lambda values for use in encoding that result in a minimized RD cost, or meet another metric in some examples.

In encoding content, the encoder 150 may generate a predictor for a macroblock, and may subtract the predictor from the macroblock to generate a residual. The encoder 150 may transform using, for example, a discrete cosine transform (DCT), the residual to provide a block of coefficients. The encoder 150 may quantize the block of coefficients based on an initial QP value and an initial lambda value. In some embodiments, the initial QP value may be selected or provided by a mode selection block, for example, during a mode decision process. The initial lambda value may be selected based on an empirical relationship between QP and lambda. In some embodiments, the empirical relationship may be:

lambda=k*Quant

where k is a constant, which may be derived based on empirical data, and Quant is a quantization step size, which may be determined based on the QP value. The encoder 150 may quantize and optimize the quantization coefficients associated with the macroblock using the lambda and QP values. The encoder 150 may determine an initial rate associated with encoding the macroblock based on the initial QP value and the initial lambda value. The encoder 150 may also reconstruct the macroblock, and may determine an initial distortion value. Based on the initial rate and distortion values, the encoder 150 may determine an RD cost. The RD cost to encode the macroblock may be represented by lambda, multiplied by the rate and the product added to the distortion, e.g.:

RD Cost=λR+D

where R represents the rate (e.g., number of bits to encode the macroblock) according to a video encoding compression standard (e.g., CABAC or CAVLC) and D the distortion. The distortion may be calculated using any of a variety of known distortion calculation techniques (e.g., sum of squared differences of the set of coefficients). Other methods of computing the RD cost may also be used. In some embodiments, the cost function may use a lambda inverse, e.g., Costₐₗₜ=λ⁻¹*D+R.

In addition to using an initial QP and lambda value to calculate a cost, the encoder 150 may determine whether a different combination of QP and lambda values provides the encoded macroblock having a lower rate R and a lower distortion D (e.g., higher quality at a lower bit cost). In an embodiment, the encoder 150 may change the QP to a new value and may modulate lambda based on the new QP value. For example, the encoder 150 may reduce the QP value by one (or a different integer value) and may modulate lambda based on the QP value that has been reduced. The encoder 150 may successively quantize a coefficient block associated with a macroblock and optimize the quantized coefficient block using the varied QP value and the modulated lambda values. Typically, lowering the QP value without altering the lambda value may result in an encoded macroblock having lower distortion (e.g., a higher quality), but also a higher rate. Thus, in order to reduce both the distortion and rate values, the encoder 150 may modulate the lambda values to determine whether a combination of the new QP value and a lambda value results in an encoded macroblock having lower rate and distortion values. For each combination of QP and lambda values evaluated, the encoder 150 may quantize a coefficient block and optimize the quantized coefficient block associated with the macroblock determine corresponding rate R values, and may reconstruct a macroblock based on the optimized quantization coefficient block to determine corresponding distortion D values. The encoder 150 may compare the corresponding rate R and distortion D values with the initial rate R and distortion D values, and select a lambda that has corresponding rate R and distortion D values that are lower than the initial rate R and distortion D values, respectively.

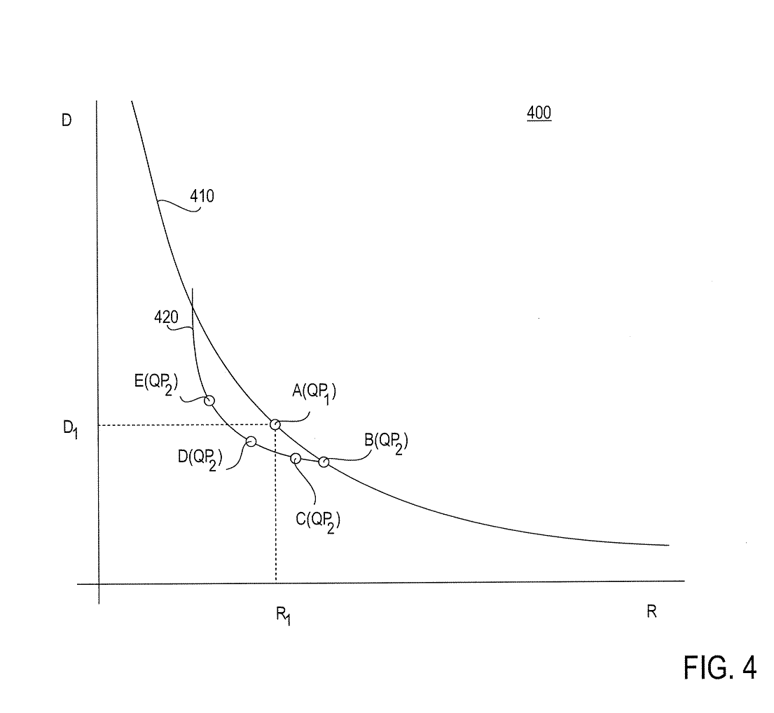

FIG. 4 illustrates a plot of a rate-distortion curve with exemplary rate R and distortion D values for different QP and lambda values. In some embodiments, the encoder 150 uses the first identified combination of QP and lambda values that result in lower rate R and distortion D values to encode the coding unit. In some embodiments, the encoder 150 may continue to modulate lambda values and encode the macroblock until an optimum lambda value in combination with the new QP value is determined. The optimum lambda value may produce a lowest rate R and distortion D in combination with the new QP value for a macroblock. In other embodiments, the encoder 150 may modulate a configurable number of lambda values and select a best combination of the new QP value and a lambda value. In some embodiments, the encoder 150 may use the initial QP and lambda values responsive to failing to detect a combination of QP and lambda values that provide a lower rate R value and a lower distortion D value for a macroblock as compared with the initial rate R and distortion D values determined using the initial QP and lambda values.

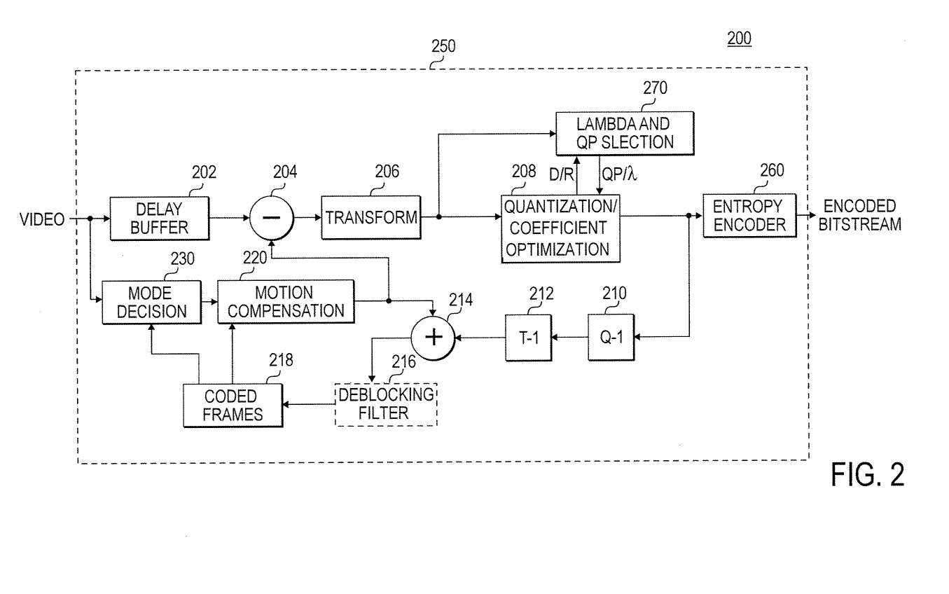

Values described herein that may be calculated, received, or otherwise utilized by the encoder may be stored in a memory accessible to the encoder (not shown in FIGS. 1 and 2). Any memory device or devices may be used to implement the memory storing the values, such as but not limited to, flash memory, disk drives, system memory, optical memory, or combinations thereof. Values stored may include, but are not limited to, QP values, lambda values, cost values, rate values, and distortion values. The values may be stored in tables or other data structures.

The encoder 150 may be implemented in all or in part utilizing a computing system. For example, the encoder 150 may be implemented using one or more processing units (e.g. processors) and one or more computer readable mediums (e.g. memories) encoded with instructions for performing all or a portion of the functions described herein. The computer readable mediums used may generally be any suitable memory including solid state memory, flash memory, disk drives, system memory, and optical memory. It is to be understood that the arrangement of computing components may be quite flexible, as may the selection of which components may be implemented using software. In other examples, hardware implementations of all or portions of the encoder may be used, for example integrated circuits may be provided that perform all or portions of the functions described herein.

FIG. 2 is a block diagram of an encoding system 200 according to an embodiment of the disclosure. The encoding system 200 may include an encoder 250, which may be used to implement the encoder 150 of FIG. 1, and may operate in accordance with one or more encoding standards in the art, known now or in the future. The encoder 250 may be implemented in semiconductor technology, and may be implemented in hardware, software, or combinations thereof. The encoder 250 may include an encoding path having a mode decision block 230, a transform block 206, a quantization/optimization block 208, and an entropy encoder 260.

The encoder 250 may include an encoding path having a mode decision module 230, a motion compensation module 220, a delay buffer 202, a transform 206, a quantization and coefficient block optimization block (quantization block) 208, and an entropy encoder 260. The mode decision module 230 may select a coding mode from a plurality of available coding modes. Available coding modes may be applied on a per coding unit basis, such as a per frame, slice, and/or macroblock basis. The coding mode may be selected based on a rate-distortion cost analysis, for example. The plurality of available coding modes from which the mode decision module 230 may select the coding mode may include, but are not limited to, intra-modes, inter-modes and/or skip/direct modes. Each of these modes may further involve a selection of a set of motion vectors (e.g. out of plurality of motion vectors provided by the motion estimation block) and/or one of a set of quantization parameters.

The output of the mode decision module 230 may be utilized by a motion compensation block 220 to generate a predictor in accordance with H.264 normative methods, MPEG-2 normative methods, or other prediction techniques. The predictor may be subtracted from a delayed version of the video signal at the subtractor 204. Using the delayed version of the video signal may provide time for the mode decision block 230 to act. The output of the subtractor 204 may be a residual, e.g. the difference between a macroblock and its prediction.

The transform 206 may be configured to perform a transform, such as a discrete cosine transform (DCT), on the residual to produce a set of blocks of coefficients (e.g. by processing the residual in blocks of 8×8 pixels or 4×4 pixels) that may, for instance, correspond to spectral components of data in the video signal. Generally, the transform 206 may transform the residual to a frequency domain representation of the residual referred to as a set of coefficient blocks.

The QP and lambda selection block 270 may provide QP values and lambda values to the quantization block 208. The quantization block 208 may also receive the block of coefficients from the transform 206. Based on the lambda and QP values, the quantization block 208 may produce a quantized block of coefficients. The quantized block of coefficients may be based on quantization strength, which may be determined based on the QP value. For example, the larger the QP value, the coarser the quantization strength may be (e.g., less detail).

The quantization provided by the quantization block 208 may be lossy. The quantization may utilize the lambda received from the QP and lambda selection block 270 to adjust and/or optimize rate-distortion tradeoff for one or more coefficients of the coefficient block. Lambda may be adjusted for each macroblock or for any other coding unit by the QP and lambda selection block 270. The quantization block 208 may provide rate and distortion values to the QP and lambda selection block 270 based on the quantization and quantized coefficient block optimization. Based on the rate and distortion cost values, the QP and lambda selection block 270 may update the QP and/or lambda values, and may provide the updated lambda and QP values to the quantization block. The process includes quantizing a coefficient block associated with a macroblock, which is performed by the QP and lambda selection block 270 and the quantization block 208, optimizing the quantized coefficient block, providing distortion and rate values, and updating lambda and QP values. The process may continue until a desired combination of QP and lambda values is determined. The lambda used may be common between the mode decision block 230 and the quantization block 208 (e.g. the same parameter may be used for rate-distortion optimization of the coding mode and rate-distortion optimization of the quantized coefficients).

The entropy encoder 260 may encode the quantized coefficient block with an encoding technique, such as CAVLC. The entropy encoder 260 may receive syntax elements (e.g., quantized coefficients, differential motion vectors, macroblock modes, etc.) from other devices of the macroblock encoder 250, such as the quantization block 208 and/or motion compensation block 220. The entropy encoder 260 may be any entropy encoder known by those having ordinary skill in the art or hereafter developed, such as a variable length coding (VLC) encoder or a binary arithmetic coding encoder (e.g. CABAC).

As discussed, in some embodiments, the encoder 250 may operate in accordance with the MPEG-2 video coding standard, the H.264 video coding standard, or combinations thereof. Thus, because the MPEG-2 and the H.264 video coding standards employ motion prediction and/or compensation, the encoder 250 may further include a feedback path that includes an inverse quantizer 210, an inverse transform 212, a reconstruction adder 214, and a deblocking filter 216 (e.g., in case of H.264 video coding standard). These elements may mirror elements included in a decoder (not shown) that is configured to reverse, at least in part, the encoding process performed by the encoder 250. Additionally, the feedback loop of the encoder may include a decoded picture buffer 218 and the motion compensation block 220.

The quantized coefficient block may be inverse quantized by the inverse quantizer (Q⁻¹) 210 to provide reconstructed coefficients, and the reconstructed coefficients for a macroblock may be inverse transformed by the inverse transform (T⁻¹) 212 to produce a reconstructed macroblock residual. The reconstructed residual may be added to the predictor at the reconstruction adder 214 and after combining with the remaining reconstructed macroblocks produce reconstructed frame, which may be deblocked by the deblocking filter 216, written to the coded frame buffer 218 for use for prediction in encoding subsequent frames, and fed back to the motion compensation block 220 and to the mode decision block 230 for further in-macroblock intra prediction or other mode decision methodologies. In some examples, the deblocking filter 216 may be removed or bypassed, and the reconstructed video frame may be provided directly to the decoded picture buffer 218 from the reconstruction adder 214.

In an example operation of the encoder 250, a video signal (e.g., a base band video signal) may be provided to the encoder 250. The encoder 250 may select a combination of QP and lambda values with which to encode macroblocks of frames of the video signal (or other coding units of the video signal) to provide an encoded video signal that has lower rate (e.g., bit cost) and distortion (e.g., better quality) values as compared with using initial QP and lambda values, e.g. those initially provided by a mode decision block or other component of an encoder or encoding system. In some examples, the initial QP and lambda values may be used to perform the encoding if, for example, no other QP and lambda value pair is identified that produces a lower rate (e.g. bit cost) and distortion (e.g. better quality). The encoder 250 may provide the video signal to the delay buffer 202 and the mode decision block 230. The subtractor 204 may receive the video signal from the delay buffer 202 and may subtract a motion prediction signal from the video signal to generate a residual. The residual may be provided to the transform 206 and processed using a forward transform, such as a DCT. The transform 206 may generate a block of coefficients that may be provided to the quantization block 208. The QP and lambda selection block 270 may receive and provide an initial QP value and an initial lambda value to the quantization block 208. The initial QP and lambda values may be selected as part of a mode decision determination. In an example, the QP and lambda values may be provided by the mode decision block 230 or a rate control module (not shown).

The quantization block 208 may quantize the block of coefficients. The quantization block 208 may adjust and/or optimize rate-distortion tradeoff based on lambda for one or more coefficients of the quantized coefficient block. Based on the optimized and quantized block of coefficients, the quantization block 208 may determine a rate value and may reconstruct a macroblock based on the block of optimized quantized coefficients to determine a distortion value. The rate and distortion values may be provided to the QP and lambda selection block 270. The QP and lambda selection block 270 may update the QP and/or lambda values based on the rate and distortion values received from the quantization block 208. The updated QP and lambda values may be provided to the quantization block 208, and the quantization block 208 may quantize the block of coefficients, optimize coefficients of the quantized block of coefficients, and reconstruct a macroblock based on the updated optimized quantized block of coefficients to determine updated rate and distortion values, which are provided to the QP and lambda selection block 270.

The updating of QP and lambda values, quantization and optimization, reconstruction, and updating rate and distortion values may continue until a combination of QP and lambda values is located which results in rate and distortion values that are lower than the initial rate and distortion values calculated using the initial QP and lambda values. In an embodiment, updating the QP and lambda values may include reducing the QP value by one and modulating the lambda value until quantization and coefficient block optimization produces the encoded macroblock having lower rate and distortion values as compared with the initial rate and distortion values. In some embodiments, the final combination of QP and lambda may be selected when an optimum combination of rate and distortion is determined, the lowest combination of rate and distortion values that was calculated after a certain number of iterations have been completed, or a specified amount of time has elapsed. The quantized coefficient block and other syntax elements may be provided to the entropy encoder 260 and encoded into an encoded bitstream. FIG. 4 illustrates a plot of a rate-distortion curve with rate and distortion values for differing QP and lambda combinations indicated.

As explained above, the quantized coefficient block may be inverse quantized, inverse transformed, and added to the motion prediction signal by the inverse quantization block 210, the inverse transform 212, and the reconstruction adder 214, respectively, to produce a reconstructed video signal. Both the motion compensation block 220 and the deblocking filter 216 (optional) may receive the reconstructed video signal, and the decoded picture buffer 218 may receive a filtered video signal from the deblocking filter 216 or the reconstructed video signal directly from the reconstruction adder 214. Based on the reconstructed and filtered video signals, the motion compensation block 220 may provide a motion prediction signal to the adder.

In some embodiments, rather than or in addition to selecting a combination of QP and lambda values that reduces rate and distortion values for a single macroblock, the encoder 250 may select a combination of QP and lambda values that reduces rate and distortion values for pairs or groups of macroblocks, such that the aggregate rate and distortion for the pair or group of macroblocks is lower as compared with the rate and distortion values associated with an initial QP and lambda combination. The above example operation is provided for illustrative purposes, and is not intended to limit the disclosure. It is appreciated that encoding of macroblocks may include other dependencies. Further, while the description uses macroblocks as coding units, it will be appreciated that other coding units may be used, such as frames, sub-frames, slices, regions, etc.

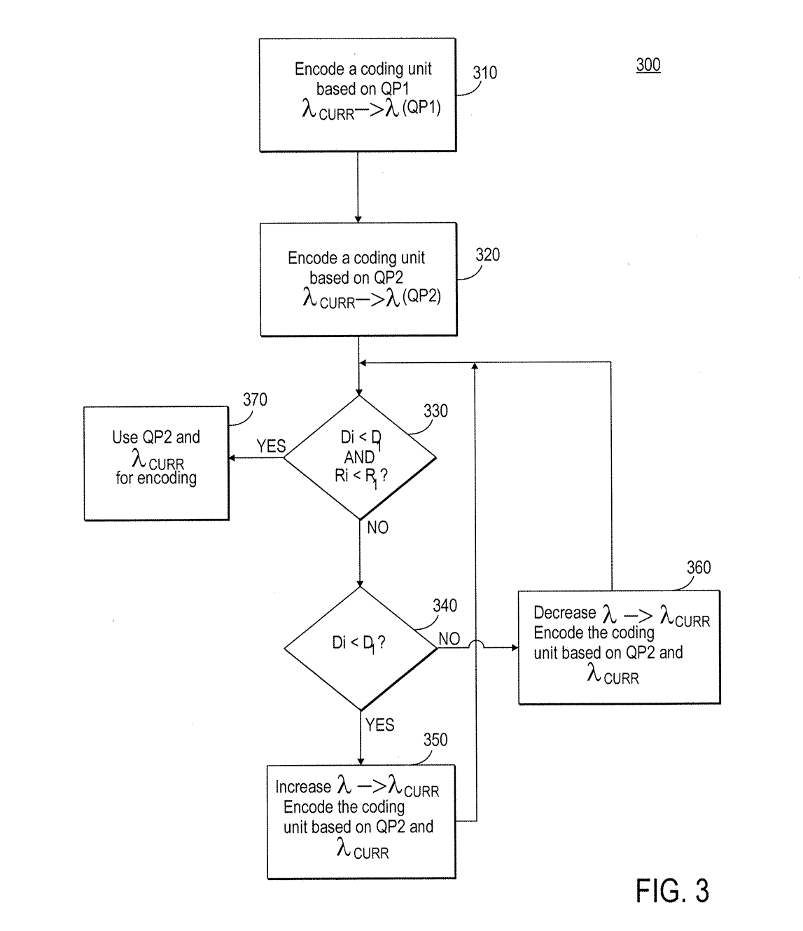

FIG. 3 is a flow diagram of a particular illustrative embodiment of a method of modulating a quantization and/or Lagrangian parameter according to an embodiment of the disclosure, and designated at 300. The method 300 may be performed by the encoder 150 of FIG. 1 and/or the encoder 250 of FIG. 2, for example. Specifically, the method 300 may be performed by the combination of quantization/coefficient optimization block 208 and lambda and QP selection block 270.

The method 300 may include encoding a macroblock based on a first QP value and a first lambda value, at 310. The first QP value and the first lambda value may be stored, for example, in a memory. The first QP value may correspond to a first quantization strength. The first lambda value may be based on the first QP value. The method 300 may include determining a first rate value and a first distortion value associated with the macroblock based on the first QP value and the first lambda value. The first rate and distortion values may be stored, for example, in a memory. Encoding the macroblock may include quantizing a coefficient block associated with the macroblock based on the first QP value, and optimizing one or more coefficients of the quantized coefficient block based on the first lambda value.

The method 300 may further include updating the QP to a second value and updating the lambda to a second value. The updated QP and lambda values may be stored, for example, in a memory. The second QP value may be less than the first QP value. The second lambda value may be determined using an empirical formula that includes the second QP value. In an embodiment, as described with reference to FIG. 1, the empirical formula be lambda=k*Quant², where k is a constant derived from empirical data and Quant is the quantization step size determined by the QP value. The method 300 may further include encoding the macroblock based on the second QP value and the second lambda value. The method 300 may include determining a second rate value and a second distortion value associated with the macroblock based on the second QP value and the second lambda value. The second rate and distortion values may be stored, for example, in a memory. Encoding the macroblock may include quantizing a coefficient block associated with the macroblock based on the second QP value, and optimizing one or more coefficients of the quantized coefficient block based on the second lambda value.

The method 300 may further include comparing the first distortion value to the second distortion value and comparing the first rate value to the second rate value, at 330. Responsive to the second distortion value being less than the first distortion value and the second rate value being less than the first rate value, the method 300 may further include encoding the macroblock based on the second QP value and the second lambda value. Alternatively, the method 300 may output the coefficients obtained at 320.

The method 300 may further include modulating the lambda value responsive to at least one of the rate or distortion values being greater than the initial rate and distortion values, respectively. For example, responsive to the second distortion value being less than the first distortion value, at 340, (e.g., the second rate value is greater than the first rate value since the comparison at step 330 produced a negative response), the method 300 may further include increasing lambda and re-quantizing and optimizing the coefficient block associated with the macroblock based on the increased lambda and the second QP value, at 350. In an embodiment, the increase in lambda may be determined according to the previous lambda values:

lambdaᵢ=lambdaᵢ₋₁+(lambdaᵢ₋₁−lambdaᵢ₋₂)

where lambda, is the current lambda, lambdaᵢ₋₁ is the lambda from a previous iteration (e.g. the last iteration), and lambdaᵢ₋₂ is a lambda from a second previous iteration (e.g. the second-to-last iteration). The initial increase (i.e. for i=1) may be performed as doubling the initial lambda value. After re-quantizing and optimizing the block of coefficients associated with the macroblock based on the second QP value and the increased lambda, new rate and distortion values may be determined, which may be compared with the initial rate and distortion values, at 330. The lambda increase process may be repeated until either simultaneous reduction in rate and distortion is achieved or the new distortion value is greater than the initial distortion value. In the former case, one may either cease lambda modulation (e.g., a desired reduction in both rate and distortion have been achieved) or continue until a stricter set of conditions is met (e.g. minimum 10% simultaneous reduction in both rate and distortion—in this case the rate and distortion values to compare against in the method 300 become 0.9 R₀ and 0.9 D₀). In the latter case the process switches to a binary search algorithm, which decreases and increases lambda in an alternating manner until the desired rate and distortion reduction is achieved.

Further, responsive to the second distortion value being greater than the first distortion value, at 340, the method 300 may further include decreasing lambda and re-quantizing and optimizing the block of coefficients associated with the macroblock based on the decreased lambda and the second QP value, at 360. In an embodiment, the decrease in lambda may be:

lambdaᵢ=(lambdaᵢ₋₁+lambdaᵢ₋₂)/2

where lambdaᵢ is the current lambda, lambdaᵢ₋₁ is the lambda from a previous iteration (e.g. the last iteration), and lambdaᵢ₋₂ is a lambda from a second previous iteration (e.g. the second-to-last iteration). The initial reduction (i.e. for i=1) may be performed as halving the initial lambda value. After re-quantizing and optimizing the block of coefficients associated with the macroblock based on the second QP value and the increased lambda, new rate and distortion values may be determined, which may be compared with the initial rate and distortion values, at 330. The lambda decrease process is repeated until either simultaneous reduction in rate and distortion is achieved or the new rate value is greater than the initial rate value. In the former case one may either cease lambda modulation (e.g., a desired reduction in both rate and distortion have been achieved) or continue until a stricter set of conditions is met (e.g. minimum 10% simultaneous reduction in both rate and distortion—in this case the rate and distortion values to compare against in the method 300 become 0.9 R₀ and 0.9 D₀). In the latter case the process switches to a binary search algorithm which increases and decreases lambda in an alternating manner until the desired rate and distortion reduction is achieved.

Increasing lambda at 350 and/or decreasing lambda at 360 may work toward fine tuning lambda until rate and distortion values are both less than the first rate and distortion values, respectively. In some embodiments, the increasing lambda at 350 and/or decreasing lambda at 360 occurs until an optimum lambda value is determined. In other embodiments, if a number of iterations or elapsing of time occurs before a lambda and QP combination is found that produces rate and distortion values that are both less than the first rate and distortion values, respectively, the first lambda and first QP value may be used to encode the macroblock.

All or certain portions of the method 300 may be performed using hardware, software, or combinations thereof. For example, encoders performing the method may include one or more processing units (e.g. processors) and memory encoded with executable instructions for performing all or one or more portions of the method 300. Encoders performing the method 300 may include hardware (e.g. circuitry) configured to perform all or one or more portions of the method 300. In this manner, an encoder may be programmed to perform the method 300 in some examples.

FIG. 4 is a plot of an exemplary rate-distortion curve with Lagrangian parameter modulation rate-distortion points indicated, according to an embodiment of the disclosure. Initial line 410 represents an exemplary embodiment of rate and distortion values for a range of QP values and, if the coefficients are undergoing optimization by default, their corresponding lambda values. Such curve can be obtained by sweeping the QP parameter within a specified range, encoding the given coding unit using each QP value and obtaining the corresponding rate and distortion values. As depicted in FIG. 4, point A(QP1) along the first line 410 indicates a rate and distortion combination for the initial QP value and the initial lambda value. These two values indicate the current operating point of the encoder. Updated line 420 represents an exemplary embodiment of rate and distortion values for a combination of an updated QP value and a variety of lambda values. As depicted in FIG. 4, point B(QP2) along the updated line 420 indicates a rate and distortion combination for the updated QP value and a second lambda value. Point C(QP2) along the updated line 420 indicates a rate and distortion combination for the updated QP value and a third lambda value. Similarly, points D(QP2) and E(QP2) along the updated line 420 indicate rate and distortion combinations for the updated QP value and fourth and fifth lambda values, respectively. Points B(QP2) and C(QP2) have a higher rate than point A(QP1) and point E(QP2) has a higher distortion than point A(QP1). Thus, of the points in FIG. 4, only point D(QP2) has rate and distortion values that are lower than the rate and distortion of point A(QP1). In the example depicted in FIG. 4, the QP and lambda values associated with point D(QP2) may be selected by the encoder and used to encode an associated macroblock, which may result in a lower rate and distortion than encoding based on the initial QP and lambda values associated with point A(QP1).

It will be appreciated that the depicted rate and distortion values for points A(QP1) and B-E(QP2) depicted in FIG. 4 are for illustrative purposes, and that the actual rate and distortion combinations may vary. Further, the initial line 410 and the updated line 420 may vary from that depicted.

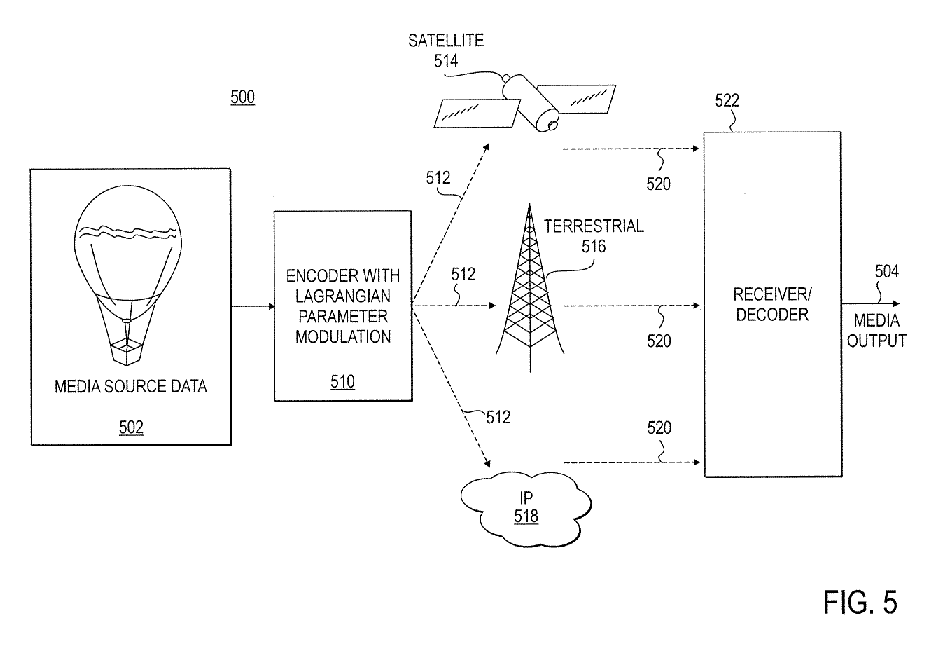

FIG. 5 is a schematic illustration of a media delivery system in accordance with embodiments. The media delivery system 500 may provide a mechanism for delivering media source data 502 to one or more of a variety of media output(s) 504. Although only one media source 502 and media output 504 are illustrated in FIG. 5, it is to be understood that any number may be used, and examples may be used to broadcast and/or otherwise deliver media content to any number of media outputs.

The media source data 502 may be any source of media content, including but not limited to, video, audio, data, or combinations thereof. The media source data 502 may be, for example, audio and/or video data that may be captured using a camera, microphone, and/or other capturing devices, or may be generated or provided by a processing device. Media source data 502 may be analog or digital. When the media source data 502 is analog data, the media source data 502 may be converted to digital data using, for example, an analog-to-digital converter (ADC). Typically, to transmit the media source data 502, some type of compression and/or encryption may be desirable. Accordingly, an encoder with QP and Lagrangian parameter modulation 510 may be provided that may encode the media source data 502 using any encoding method in the art, known now or in the future, including encoding methods in accordance with video standards such as, but not limited to, MPEG-2, MPEG-4, H.264, HEVC, or combinations of these or other encoding standards. The encoder with QP and Lagrangian parameter modulation 510 may be implemented using any encoder according to an embodiment of the invention, including the encoder 150 of FIG. 1 and the encoder 250 of FIG. 2, and further may be used to implement the method 300 of FIG. 3.

The encoded data 512 may be provided to a communications link, such as a satellite 514, an antenna 516, and/or a network 518. The network 518 may be wired or wireless, and further may communicate using electrical and/or optical transmission. The antenna 516 may be a terrestrial antenna, and may, for example, receive and transmit conventional AM and FM signals, satellite signals, or other signals known in the art. The communications link may broadcast the encoded data 512, and in some examples may alter the encoded data 512 and broadcast the altered encoded data 512 (e.g., by re-encoding, transcoding, adding to, or subtracting from the encoded data 512). The encoded data 520 provided from the communications link may be received by a receiver 522 that may include or be coupled to a decoder. The decoder may decode the encoded data 520 to provide one or more media outputs, with the media output 504 shown in FIG. 5.

The receiver 522 may be included in or in communication with any number of devices, including but not limited to a modem, router, server, set-top box, laptop, desktop, computer, tablet, mobile phone, etc.

The media delivery system 500 of FIG. 5 and/or the encoder with QP and Lagrangian parameter modulation 510 may be utilized in a variety of segments of a content distribution industry.

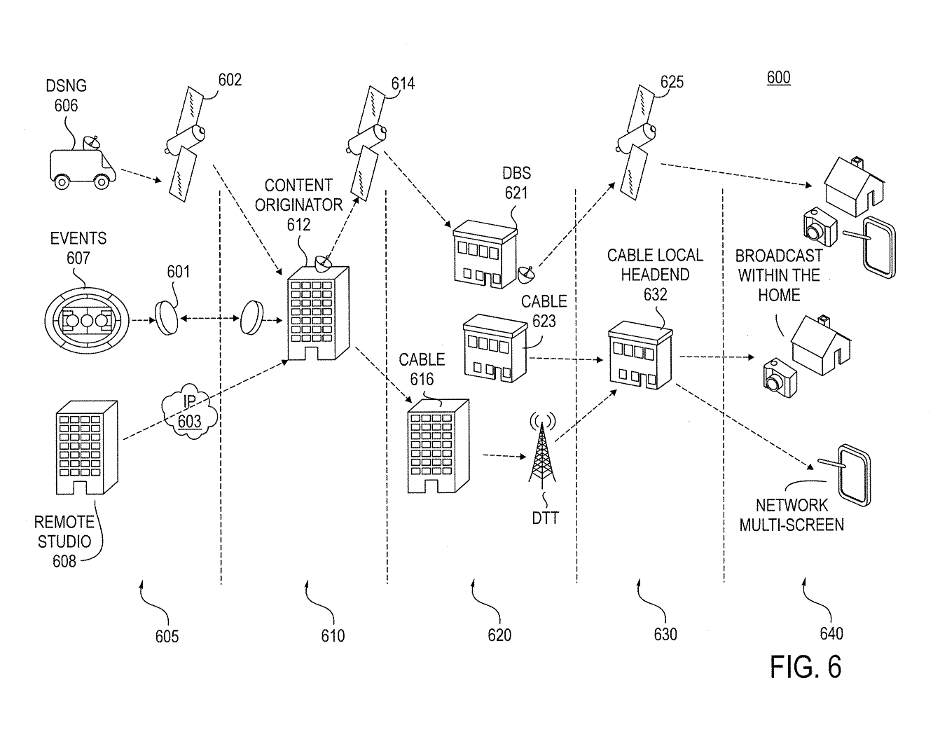

FIG. 6 is a schematic illustration of a video distribution system 600 that may make use of encoders described herein. The video distribution system 600 includes video contributors 605. The video contributors 605 may include, but are not limited to, digital satellite news gathering systems 606, event broadcasts 607, and remote studios 608. Each or any of these video contributors 605 may utilize an encoder described herein, such as the encoder with QP and Lagrangian parameter modulation 510 of FIG. 5, to encode media source data and provide encoded data to a communications link. The digital satellite news gathering system 606 may provide encoded data to a satellite 602. The event broadcast 607 may provide encoded data to an antenna 601. The remote studio 608 may provide encoded data over a network 603.

A production segment 610 may include a content originator 612. The content originator 612 may receive encoded data from any or combinations of the video contributors 605. The content originator 612 may make the received content available, and may edit, combine, and/or manipulate any of the received content to make the content available. The content originator 612 may utilize encoders described herein, such as the encoder with QP and Lagrangian parameter modulation 510 of FIG. 5, to provide encoded data to the satellite 614 (or another communications link). The content originator 612 may provide encoded data to a digital terrestrial television system 616 over a network or other communication link. In some examples, the content originator 612 may utilize a decoder to decode the content received from the contributor(s) 605. The content originator 612 may then re-encode data; potentially utilizing encoders described herein, such as the encoder with QP and Lagrangian parameter modulation 510 of FIG. 5, and provide the encoded data to the satellite 614. In other examples, the content originator 612 may not decode the received data, and may utilize a transcoder (which may include an encoder with QP and Lagrangian parameter modulation 510 of FIG. 5) to change an encoding format or other parameters of the received data.

A primary distribution segment 620 may include a digital broadcast system 621, the digital terrestrial television system 616, and/or a cable system 623. The digital broadcasting system 621 may include a receiver, such as the receiver 522 described with reference to FIG. 5, to receive encoded data from the satellite 614. The digital terrestrial television system 616 may include a receiver, such as the receiver 522 described with reference to FIG. 5, to receive encoded data from the content originator 612. The cable system 623 may host its own content which may or may not have been received from the production segment 610 and/or the contributor segment 605. For example, the cable system 623 may provide its own media source data 502 as that which was described with reference to FIG. 5.

The digital broadcast system 621 may include an encoder, such as the encoder with QP and Lagrangian parameter modulation 510 of FIG. 5, to provide encoded data to the satellite 625. The cable system 623 may include an encoder, such as the encoder with QP and Lagrangian parameter modulation 510 of FIG. 5, to provide encoded data over a network or other communications link to a cable local headend 632. A secondary distribution segment 630 may include, for example, the satellite 625 and/or the cable local headend 632.

The cable local headend 632 may include an encoder, such as the encoder with QP and Lagrangian parameter modulation 510 of FIG. 5, to provide encoded data to clients in a client segment 640 over a network or other communications link. The satellite 625 may broadcast signals to clients in the client segment 640. The client segment 640 may include any number of devices that may include receivers, such as the receiver 522 and associated decoder described with reference to FIG. 5, for decoding content, and ultimately, making content available to users. The client segment 640 may include devices such as set-top boxes, tablets, computers, servers, laptops, desktops, cell phones, etc.

Accordingly, encoding, transcoding, and/or decoding may be utilized at any of a number of points in a video distribution system. Embodiments may find use within any, or in some examples all, of these segments.

From the foregoing it will be appreciated that, although specific embodiments of the disclosure have been described herein for purposes of illustration, various modifications may be made without deviating from the spirit and scope of the disclosure. Accordingly, the disclosure is not limited except as by the appended claims.

What is claimed is:

1. An apparatus, comprising:
an encoder configured to provide an encoded bitstream based on a video signal, the encoder configured to:
determine first rate and distortion values associated with a first quantization strength and a first Lagrangian parameter value for encoding a coding unit of the video signal; and
select a second quantization strength and a second Lagrangian parameter value for encoding the coding unit that results in second rate and distortion values that are lower than the first rate and distortion values.

2. The apparatus of claim 1, wherein the encoder comprises a quantization and optimization block that is configured to:
determine the first rate and distortion values;
Quantize a block of coefficients associated with the coding unit based on the first quantization strength; and
optimize one or more coefficients of the quantized block of coefficients based on the first Lagrangian parameter value.

3. The apparatus of claim 1, wherein the first quantization strength is based on a first quantization parameter value, and wherein the second quantization strength is based on a second quantization parameter value.

4. The apparatus of claim 3, wherein the encoder comprises a lambda and QP selection block that is configured to select the second quantization parameter value and to select modulated Lagrangian parameter values, wherein the modulated Lagrangian parameter values include the second Lagrangian parameter value.

5. The apparatus of claim 4, wherein the encoder further comprises a quantization block that is configured to, for each combination of the second quantization parameter value and Lagrangian parameter value of the modulated Lagrangian parameter values, quantize a block of coefficients associated with the coding unit based on the second quantization parameter value and to optimize one or more coefficients of the quantized block of coefficients based on a Lagrangian parameter value.

6. The apparatus of claim 5, wherein the quantization block is further configured to provide rate and distortion values for each combination of the second QP value and the modulated Lagrangian parameter values to the lambda and QP selection block.

7. The apparatus of claim 5, wherein the lambda and QP selection block is further configured to adjust the Lagrangian parameter value based on the second rate and distortion values.

8. The apparatus of claim 7, wherein responsive to the second distortion value being greater than the first distortion value, the lambda and QP selection block is configured to decrease a value of the first Lagrangian parameter to result in the second Lagrangian parameter.

9. The apparatus of claim 7, wherein responsive to the rate value being greater than the first rate value, the lambda and QP selection block is configured to increase a value of Lagrangian parameter to result in the second Lagrangian parameter.

10. At least one non-transitory computer-readable medium encoded with instructions that, when executed by one or more processing units, cause the one or more processing units to:
determine an initial rate value and an initial distortion value based on an initial plurality of quantized coefficient blocks, wherein individual ones of the initial plurality of quantized coefficient blocks are associated with a respective coding unit, wherein each of the initial plurality of quantized coefficient blocks corresponds to one of a plurality of coefficient blocks that was quantized based on a respective initial quantization parameter value and a respective initial Lagrangian parameter value; and
iteratively determine corresponding rate values and corresponding distortion values based on quantizing and optimizing the plurality of blocks of coefficients using respective updated quantization parameter values and one or more respective modulated Lagrangian parameter values; and
select, for each of the plurality of blocks of coefficients, a respective combination of the respective updated quantization parameter value and a respective Lagrangian parameter value of the one or more respective modulated Lagrangian parameter values that result in:
a corresponding distortion value being lower than the initial distortion value; and
a corresponding rate value being lower than the initial rate value.

11. The at least one non-transitory computer-readable medium of claim 10, further comprising instructions that, when executed by the one or more processing units, cause the one or more processing units to iteratively quantize and optimize the plurality of blocks of coefficients based on the respective updated quantization parameter values and the respective modulated Lagrangian parameter values.

12. The at least one non-transitory computer-readable medium of claim 11, wherein the instructions that, when executed by one or more processing units, cause the one or more processing units to iteratively determine corresponding distortion values based on quantizing and optimizing the plurality of coefficient blocks comprises reconstructing respective coding units based on each quantized and optimized block of coefficients of the plurality of blocks of coefficients.

13. The at least one non-transitory computer-readable medium of claim 11, further comprising instructions that, when executed by the one or more processing units, cause the one or more processing units to, after each iteration of quantizing the plurality of coefficient blocks:
compare the corresponding distortion value to the initial distortion value;
compare the corresponding rate value to the initial rate value; and
update the respective Lagrangian parameter values for each of the plurality of coefficient blocks based on the comparison of the corresponding distortion value to the initial distortion value and based on the comparison of the corresponding rate value to the initial rate value.

14. A method, comprising:
determining an initial rate value and an initial distortion value based on an initial quantized block of coefficients associated with a coding unit, wherein the initial quantized block of coefficients was quantized based on an initial quantization parameter value and an initial Lagrangian parameter value; and
updating the quantization parameter to an updated value;
iteratively quantizing the block of coefficients based on the updated quantization parameter value and one or more modulated Lagrangian parameter values;
selecting a combination of the updated quantization parameter value and a Lagrangian parameter value of the one or more modulated Lagrangian parameter values responsive to determining that the updated quantization parameter value and the Lagrangian parameter value provide a block of quantized coefficients that correspond with:
a distortion value that is lower than the initial distortion value; and
a rate value that is lower than the initial rate value.

15. The method of claim 14, further comprising determining a corresponding distortion value and a corresponding rate value for each iteration of quantizing the block of coefficients based on the updated quantization parameter value and the one or more modulated Lagrangian parameter values.

16. The method of claim 15, further comprising, after each iteration of quantizing the block of coefficients, comparing the corresponding distortion value to the initial distortion value and the corresponding rate value to the initial rate value.

17. The method of claim 16, further comprising updating the Lagrangian parameter value based on the comparison of the corresponding distortion value to the initial distortion value and based on the comparison of the corresponding rate value to the initial rate value.

18. The method of claim 17, wherein updating the Lagrangian parameter value based on the comparison of the corresponding distortion value to the initial distortion value comprises decreasing the Lagrangian parameter value from an immediately previous iteration of quantizing the coefficient block responsive to the corresponding distortion value being greater than the initial distortion value.

19. The method of claim 17, wherein updating the Lagrangian parameter value based on the comparison of the corresponding rate value to the initial rate value comprises increasing the Lagrangian parameter value from an immediately previous iteration of quantizing the coefficient block responsive to the corresponding rate value being greater than the initial rate value.

20. The method of claim 14, wherein the coding unit is a macroblock.
